(19) United States
(12) Patent Application Publication
(10) Pub. No.: US 2014/0253390 A1
(43) Pub. Date: Sep. 11, 2014

(54) PASSIVE WIRELESS TRANSMITTER AUTHENTICATION USED FOR RECEIVER LOCATION DETERMINATION

(71) Applicants: Yaron Alpert, Hod Hasharoni (IL); Gil Zuckerman, Hod-HaSharon (IL)

(72) Inventors: Yaron Alpert, Hod Hasharoni (IL); Gil Zuckerman, Hod-HaSharon (IL)

(21) Appl. No.: 13/785,723

(22) Filed: Mar. 5, 2013

(51) Int. Cl. G01S 5/02

(52) U.S. Cl. CPC G01S 5/02
USPC 342/464

(57) ABSTRACT

A client device includes an application to request a client device location, and a receiver to receive a signal from a transmitter. The receiver extracts a transmitter identifier (ID) and a wave propagation parameter (WPP) from the signal. A validator validates the extracted transmitter ID based on comparisons of the extracted ID against a list of pre-assigned transmitter IDs. A location calculator computes the client device location based at least in part on the extracted WPP and provides the computed client device location to the application, if the transmitter ID is validated by the validator.

### BACKGROUND

A conventional mobile device location system includes a mobile device to receive signals transmitted from geographically spaced transmitters, which may be terrestrial-based transmitters. The mobile device may extract a wave propagation parameter (WPP) from each received signal, such as a received signal strength (RSS) or received signal time-of-arrival (TOA). The receiver triangulates its location using the extracted WPPs. A nefarious system attacker may spoof, or falsify, one or more of the transmitted signals, which may result in an erroneous location determination in the mobile device. Conventionally, to combat spoofing, the mobile device actively exchanges information with each of the transmitters directly in order to validate their authenticity. Such active validation/authentication requires that the mobile device transmit information to each of the transmitters, which disadvantageously consumes limited battery power in the mobile device and, in covert applications, may reveal the presence of the mobile device.

### BRIEF DESCRIPTION OF THE DRAWINGS

FIG. 1 is a block diagram of an example system to compute authenticated location information related to a client device.

FIG. 2 is a sequence diagram of example interactions among components of the system of FIG. 1.

FIG. 3 is a block diagram of another example system to compute authenticated location related to a client device or multiple client devices.

FIG. 4 is a flowchart of an example method of computing authenticated location information related to a client device.

FIG. 5 is a block diagram of an example computer system.

FIG. 6 is a block diagram of an example client device.

In the drawings, the leftmost digit(s) of a reference number identifies the drawing in which the reference number first appears.

### DETAILED DESCRIPTION

Embodiments described herein are directed to passive authentication/validation of transmitters and the signals they transmit, and the computation of client device location information (such as a client device location) based on the authenticated signals. The embodiments are considered passive because the client device relies only on signals that are received by the client device to authenticate/validate the transmitters, and thereby authenticate the location information computation. That is, the client device performs the transmitter authentication and the location information computation without transmitting signals to the transmitters. The computed location information is also referred to herein as an “authenticated location information” because it is computed based on authenticated transmitters and transmitter signals.

Embodiments described herein may be incorporated in one or more devices of a wireless local area network (WLAN) that operates in accordance with any number of wireless standards, such as the Institute of Electrical and Electronics Engineers (IEEE) 802.11 standards. Alternatively, the embodiments may be incorporated in one or more devices of a wired network. Alternatively, the embodiments may be incorporated in stand-alone point-to-point communication systems that are not part of a network.

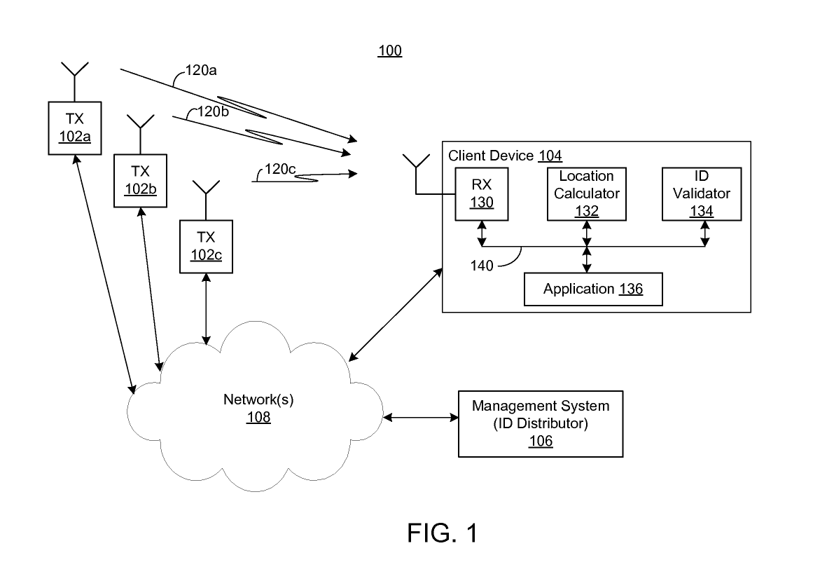

FIG. 1 is a block diagram of an example system 100 to compute an authenticated location of a client device. System 100 includes one or more transmitters 102a-102c (each transmitter is denoted with “TX,”) a client device 104, a management system 106 including an identifier (ID) distributor, and a communication network 108 over which the transmitters, the client device, and the ID distributor may communicate with each other.

Each of transmitters 102 is provisioned with a pre-assigned unique transmitter ID (also referred to herein as simply an “ID”). To provision transmitters 102, the ID distributor of management system 106 may distribute the IDs to the transmitters over network 108, and/or the IDs may be programmed into the transmitters when they are initially configured and/or authorized. Transmitters 102a-102c generate corresponding signals 120a-120c that include their corresponding IDs, and transmit the signals (carrying the IDs) to client device 104. Transmitters 102 may include, e.g., network transmitters, cellular base station transmitters, wireless routers, satellite-based transmitters, or any other type of transmitter. Transmit signals 120 may include, but are not limited to, wireless signals, such as radio frequency (RF) signals, including Time Division Multiple Access (TDMA) signals, Code Division Multiple Access (CDMA) signals, hybrid signals, or any other type of signal.

Client device 104 includes the following modules: a receiver (RX) 130 to receive and process signals 120a-120c when received; a location calculator 132 to calculate location information related to the client device, such as a location of the client device, using the processed signals; an ID validator 134 to validate transmitter IDs carried in the signals; an application 136, such as a user application, that executes on the client device and utilizes (needs) location information related to the client device; and one or more communication links 140, over which the aforementioned client device modules may communicate, e.g., exchange information and messages. Client device 104 may be provisioned with transmitter-related information described below, and which may be stored in ID validator 134, for example.

The transmitter-related information may include (i) a list of valid transmitter IDs, e.g., the IDs of deployed transmitters 102, (ii) for each listed ID, a real-world (deployed) location, i.e., geographical coordinates of the actual transmitter associated with that ID, and (iii) in some embodiments, a predetermined transmit power level of the actual transmitter associated with that ID.

Example transmitter-related information is provided in Table 1 below:

TABLE 1

| | Geographical Location | |
|---|---|---|
| | (e.g., x, y, z and/or | Transmit |
| Valid | latitude (lat)/ | Power |
| Transmitter | longitude (long) | (TP) |
| ID | coordinates) | (Watts) |
| 0 | x₀, y₀, z₀ - lat₀/long₀ | TP₀ |
| 1 | x₁, y₁, z₁ - lat₁/long₁ | TP₁ |
| 2 | x₂, y₂, z₂ - lat₂/long₂ | TP₂ |

Similar to the way in which transmitters 102 are provisioned with their corresponding IDs, the ID distributor of management system 106 may distribute the transmitter-related information to client device 104 over network 108. Additionally, or alternatively, the transmitter-related information may be programmed into the client device when it is initially configured and/or authorized.

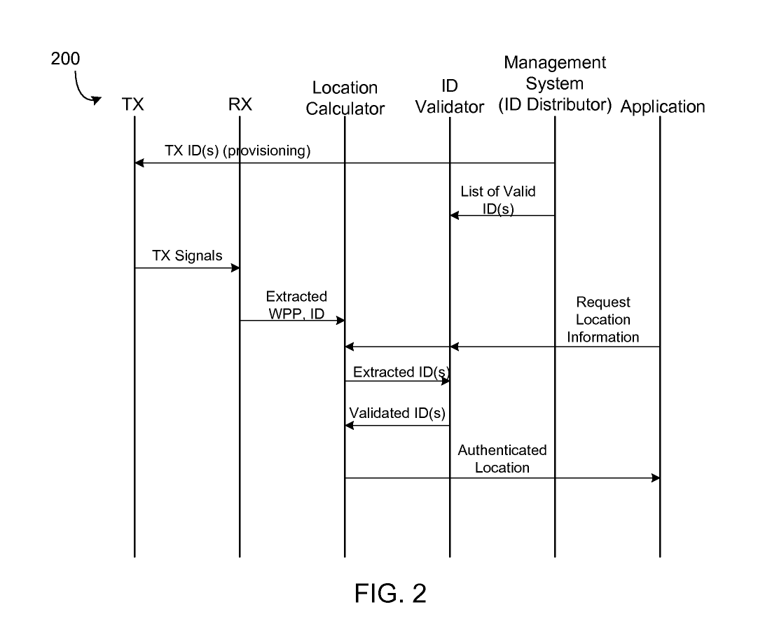

FIG. 2 is a sequence diagram of example high-level interactions 200, among management system 106, transmitters 102, and client device 104 (and between the modules of the client device) of system 100, involved in computing authenticated location information related to the client device. Interactions 200 progress in time from top-to-bottom in FIG. 2, beginning with transmitter ID provisioning. First, the ID distributor of management system 106 may distribute the transmitter IDs to transmitters 102. Then, the ID distributor may distribute the transmitter-related information, including the list of valid IDs, to ID validator 134 in client device 104.

Transmitters 102 transmit their signals 102, including their corresponding IDs, to client device 104. The IDs may be transmitted repetitively.

Client device RX 130 receives the transmitted signals 102, and processes the received signals to extract from each of them (i) the ID included in the signal, and (ii) a wave propagation parameter (WPP) of the signal, e.g., a time-of-arrival of the signal, or a signal strength, such as a received power level, of the signal. RX 130 passes the extracted IDs and WPPs to location calculator 132.

Application 136 sends a request for location information related to client device 104 to location calculator 132 and ID validator 134. The request may be sent earlier or later than as indicated in diagram 200. In response, location calculator 132 and ID validator 134 cooperate to determine and authenticate location information, if possible, as described below.

Location calculator 132 provides the extracted IDs to ID validator 134. ID validator 134 validates the extracted IDs based on comparisons between the extracted IDs and the provisioned list of valid IDs, i.e., the ID validator determines which of the extracted IDs are valid (i.e., validated) based on the comparisons. ID validator 134 reports validated IDs, if any, to location calculator 132. It is to be understood that when an extracted ID is validated, for purposes of further processing in client device 104, the received signal from which the validated ID was extracted, the WPP extracted from the received signal, and the transmitter from which the received signal originated are also all considered validated. In other words, a validated ID corresponds to a validated received signal, a validated WPP, and a validated transmitter.

If one or more validated IDs are reported to location calculator 132, then the location calculator computes the requested location information based at least in part on the one or more validated WPPs extracted from the corresponding ones of the validated received signals. Because the location information is based on validated WPPs, the location information is considered validated or authenticated location information.

Location calculator 132 may require a predetermined number of validated IDs (and thus correspondingly validated WPPs) before the location information is computed. The predetermined required number of validated IDs may be, e.g., one, two, or three. Alternatively, more than three validated IDs may be required. Location information computed using only one validated WPP may represent only a range from client device 104 to the corresponding validated transmitter, whereas location information computed using at least three validated WPPs (corresponding to three validated transmitters) may represent a triangulated location of the client device. Different techniques for computing a location based on one or more WPPs are described in more detail below under the section heading “Location Determination.”

If location calculator 132 is able to compute the authenticated location information based on one or more validated WPPs (from one or more corresponding validated received signals), and, in the event that a predetermined number of validated IDs are required and that number has been met, then the location calculator reports the authenticated location information to application 136 in response to its initial request for the location information. Otherwise, location calculator 132 may deny the request. Such denial may be in the form of a denial response from location calculator 132 to application 136, or the location calculator may simply not respond to the initial request.

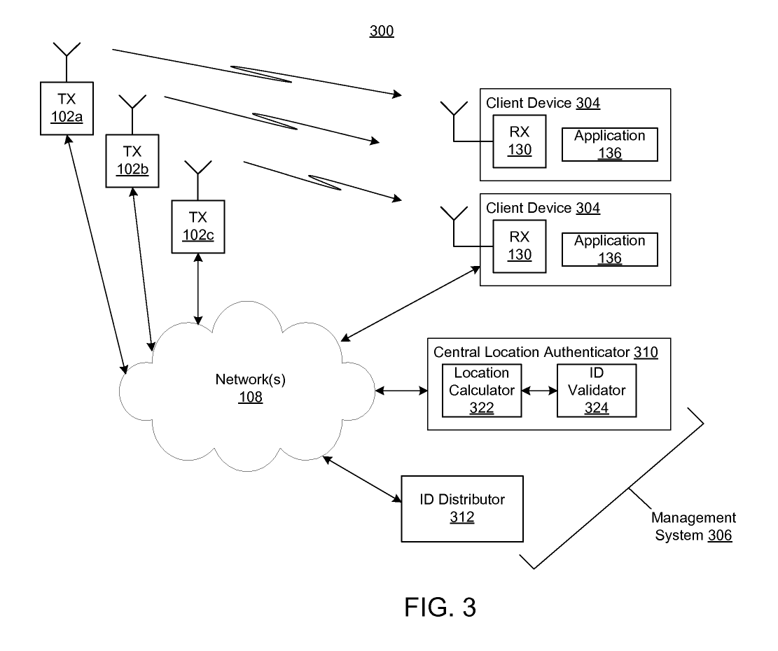

FIG. 3 is a block diagram of another example system 300 to compute an authenticated location of one or more client devices. Compared to system 100, system 300 shifts the functionality of the location calculator and ID validator from each client device 304 to a common or central entity, namely, a management system 306, and thereby obviates the need (i) for a client device that is specially configured and provisioned to determine and authenticate location information, and (ii) to distribute lists of valid IDs to multiple client devices.

Management system 306 includes a central location authenticator (CLA) 310 and an ID distributor 312. Management system 306 may be implemented on a server computer, for example. ID distributor 312 is configured to operate similarly to the ID distributor of system 100. CLA 310 (i) receives requests for location information and extracted received signal information (i.e., WPPs and IDs) from multiple client devices 304, (ii) in response to the requests, centrally determines and authenticates location information related to each of the client devices, individually, and then (iii) communicates the location information to corresponding ones of the requesting client devices, as appropriate. CLA 310 may be separated geographically from client devices 304, or may be co-located with the client devices.

CLA 310 includes a common location calculator 322 and a common ID validator 324. ID validator 324 may be provisioned with the same transmitter-related information used to provision client device(s) 104 in system 100, including lists of valid transmitter IDs corresponding to the geographical operating areas of each client device 304. In accordance with sequence diagram 200, each client device 304 sends its location information request, as well as the IDs and the WPPs extracted from its locally received signals, to location calculator 322 over network 108, or directly via wireless transmission. Location calculator 322 and ID validator 324 are configured to operate as described above to determine and authenticate location information for each client device 304, and send the authenticated location information to the client device over network 108.

Location Determination

Once the geographical coordinates of transmitters 102 are known, the location of a client device, e.g., client device 104, receiving signals 120 may be determined using any suitable locating algorithm. In an embodiment in which client device 104 extracts or measures the signal strength of the received signal (corresponding to any of signals 120) as the WPP, the predetermined transmit power of each transmitter is compared to the received signal strength to calculate the location of client device 104. As an approximation, the received signal strength may be considered to be inversely proportional to the distance between client device 104 and the transmitter.

Using received signal strengths corresponding to multiple transmitters improves the accuracy of the client device location. For example, using received signal strength from a single transmitter locates the client device to a radial distance between the client device and the transmitter (i.e., locates the client device on any point of a circumference of a circular area surrounding the transmitter, where the circular area has a radius equal to a distance between the client device and the transmitter). Using received signal strengths from two transmitters locates the client device to one of two points where the circumferences of the two circular areas overlap. Using received signal strengths from three or more transmitters triangulates the location of the client device to a point.

In an embodiment in which client device 104 measures or extracts a time-of-arrival (TOA) of a received signal as the WPP, time differences between the TOAs extracted from multiple received signals may be used to triangulate the location of the client device, assuming that the transmitter locations are known, as would be appreciated by those having ordinary skill in the relevant arts.

Method Flow Chart

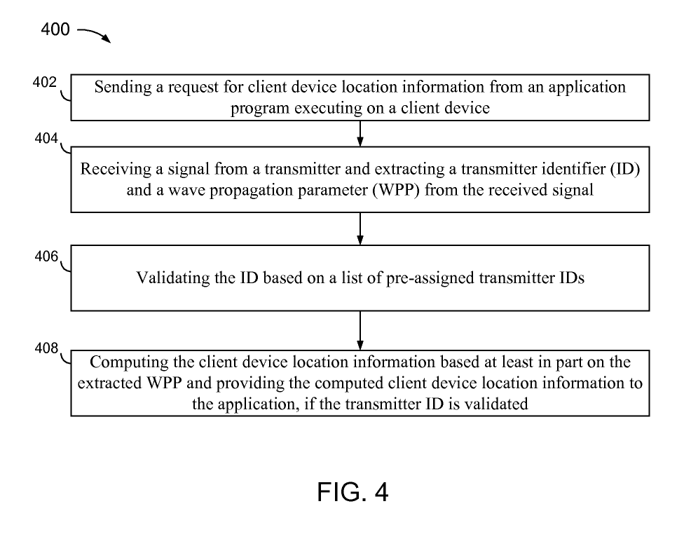

FIG. 4 is a flowchart of an example method 400 to authenticate transmitter signals (and the transmitters from which they originate) and compute authenticated location information (e.g., a client device location) based on the authenticated signals.

402 includes sending a request for client device location information from an application program executing on a client device.

404 includes receiving a signal from a transmitter and extracting a transmitter ID and a WPP from the received signal.

406 includes validating the ID based on a list of pre-assigned transmitter IDs. The ID is validated passively based only on received signals only, i.e., without transmitting information from the client device to the transmitter.

408 includes computing the client device location information based at least in part on the extracted WPP and providing the computed client device location information to the application, if the transmitter ID is validated.

In an embodiment, 404 includes receiving signals from multiple transmitters and extracting an ID and a WPP from each of the received signals, 406 includes validating each of the extracted IDs, and 408 includes computing the client device location information based on the WPPs extracted from the received signals of a pre-determined number of the transmitters that is greater than one, e.g., three, and denying the request if the pre-determined number of corresponding transmitter IDs are not able to be validated in 406.

Computer and System

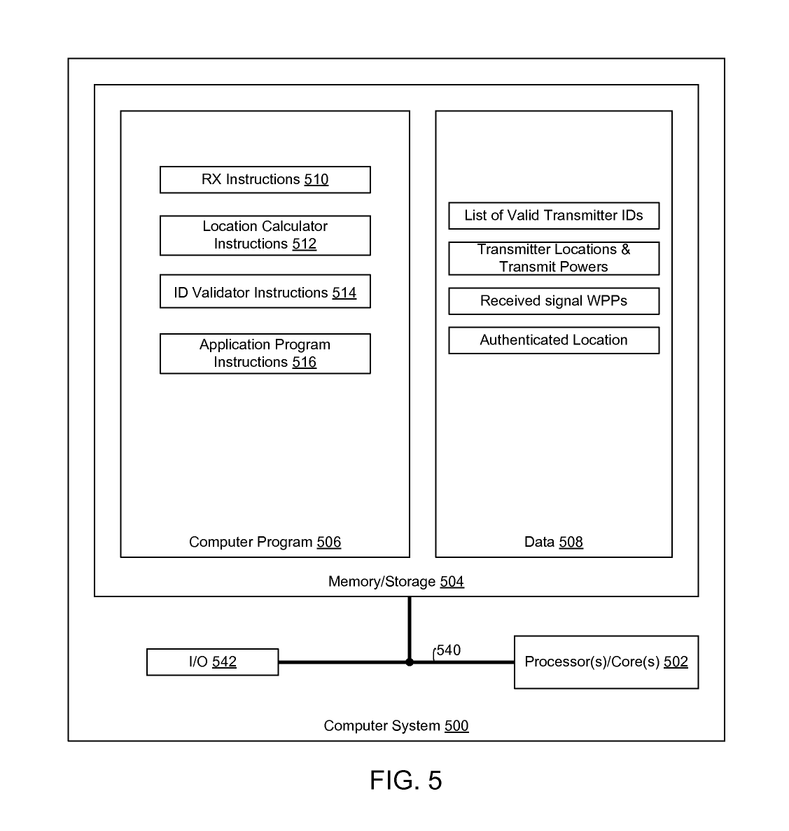

FIG. 5 is a block diagram of a computer system 500, configured to passively authenticate/validate transmitters and the signals they transmit, and compute client device location information (such as a client device location) based on the authenticated signals.

Computer system 500 includes one or more computer instruction processor units and/or processor cores, illustrated here as a processor 502, to execute computer readable instructions, also referred to herein as computer program logic. Processor 502 may include a general purpose instruction processor, a controller, a microcontroller, or other instruction-based processor.

Computer system 500 may include memory, cache, registers, and/or storage, illustrated here as memory 504, which may include a non-transitory computer readable medium encoded with a computer program, illustrated here as a computer program 506.

Memory 504 may include data 508 to be used by processor 502 in executing computer program 506, and/or generated by processor 502 during execution of computer program 506. Data 508 may include provisioned transmitter-related information, such as one or more lists of valid transmitter IDs and their associated transmit powers and geographical locations, received signal WPPs, and authenticated client device locations.

Computer program 506, also referred to as computer program logic or software, may be encoded within a computer readable medium, which may include a non-transitory medium. In the example of FIG. 5, computer program 506 includes receiver (RX) instructions 510 to cause processor 502 to extract IDs and WPPs from the received signals, such as described in one or more examples above. Computer program 506 includes location calculator instructions 512 to cause processor 502 to compute authenticated location information, ID validator instructions 514 to cause processor 502 to validate extracted IDs, and application program instructions 516 to cause the processor to execute an application program, such as described in one or more examples above.

Computer system 500 may include communications infrastructure 540 to communicate amongst devices and/or resources of computer system 500.

Computer system 500 may include one or more input/output (I/O) devices and/or controllers 542 to communicate with one or more other systems, such as with a transmitter system and/or a receiver system.

In embodiments, components of computer system 500 directed to receive processing and the application program (including RX instructions 510 and application program instructions 516) and components directed to computing and validating/authenticating (including location calculator instructions 512 and ID validator instructions 514) may reside in physically separate devices, e.g., the receive processing and application program may reside in a client device, while the computing and authenticating components may reside in a server device, as would be apparent to one having ordinary skill in the relevant arts.

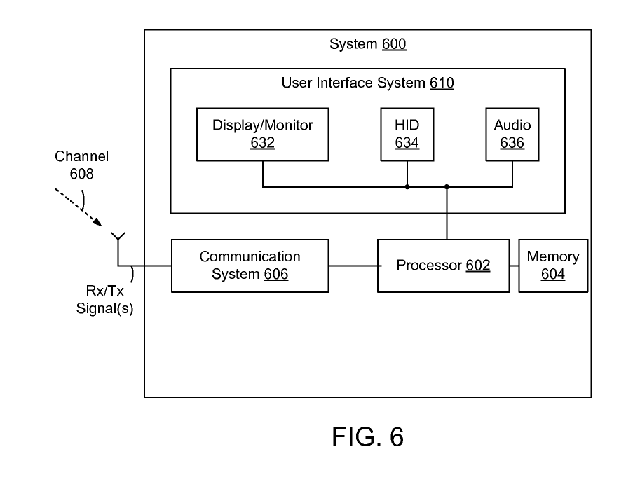

Methods and systems disclosed herein may be implemented with respect to one or more of a variety of systems, such as described below with reference to FIG. 6. Methods and systems disclosed herein are not, however, limited to the examples of FIG. 6.

FIG. 6 is a block diagram of a system 600, including a processor system 602, memory or storage 604, a communication system 606, and a user interface system 610. Communication system 606 may include one or more radio frequency (RF) systems, such as an RF transmitter system, an RF receiver system (e.g., receiver RX), as described in one or more examples above. A location calculator and ID validator may be implemented in processor and memory systems 602, 604.

Memory 604 may be accessible to processor system 602, communication system 606, and/or user interface system 610.

User interface system 610 may include a monitor or display 632 and/or a human interface device (HID) 634. HID 634 may include, without limitation, a key board, a cursor device, a touch-sensitive device, a motion and/or image sensor, a physical device and/or a virtual device, such as a monitor-displayed virtual keyboard. User interface system 610 may include an audio system 636, which may include a microphone and/or a speaker.

System 600 may correspond to, for example, a client device, a computer system and/or a communication device and may include a housing such as, without limitation, a rack-mountable housing, a desk-top housing, a lap-top housing, a notebook housing, a net-book housing, a tablet housing, a telephone housing, a set-top box housing, and/or other conventional housing and/or future-developed housing. Processor system 602, storage 604, communication system 606, and user interface system 610, or portions thereof, may be positioned within the housing.

System 600 or portions thereof may be implemented within one or more integrated circuit dies, and may be implemented as a system-on-a-chip (SoC).

The following examples pertain to further embodiments.

Example 1 includes a system to compute device location information, comprising:

a client device including a receiver to receive a signal from a transmitter and to extract a transmitter identifier (ID) and a wave propagation parameter (WPP) from the signal;

a validator to validate the transmitter ID based on a list of pre-assigned transmitter IDs; and

a location calculator to compute client device location information based at least in part on the extracted WPP, if the transmitter ID is validated by the validator.

Example 2 includes the subject matter of Example 1, wherein:

the client device further includes an application to request the client device location information; and

the location calculator is further configured to provide the computed client device location information to the application.

Example 3 includes the subject matter of Example 2, wherein:

the receiver is configured to receive signals from multiple transmitters and to extract a transmitter ID and a WPP from each of the signals; and

the location calculator is configured to

compute client device location information based on the WPPs extracted from the received signals of a pre-determined number of the transmitters that is greater than one, and

deny the request if the pre-determined number of corresponding transmitter IDs are not validated by the validator.

Example 4 includes the subject matter of Example 1, wherein the client device includes the location calculator.

Example 5 includes the subject matter of Example 1, wherein the client device includes the validator.

Example 6 includes the subject matter of Example 1, wherein the client device includes the location calculator and the validator.

Example 7 includes the subject matter of Example 1, further including a management system, including the validator, wherein the validator is configured to validate transmitter IDs for multiple client devices.

Example 8 includes the subject matter of Example 1, further including a management system, including the location calculator, wherein the location calculator is configured to compute location information for each of multiple client devices.

Example 9 includes the subject matter of Example 1, wherein the client device further comprises:

a communication system that includes the receiver;

a user interface;

a processor and memory to communicate with the communication system and the user interface; and

a housing to house the communication system, the user interface, and the processor and memory.

Example 10 includes the subject matter of Example 9, wherein:

the communication system includes a wireless communication system; and

the housing includes a mobile hand-held housing to receive the communication system, the user interface, the processor and memory, and a battery.

Example 11 is a non-transitory computer readable medium encoded with:

a validator computer program including instructions to cause the processor to validate a transmitter ID extracted from a signal received at a client device from a transmitter based on a list of pre-assigned transmitter IDs; and

a location calculator computer program including instructions to cause the processor to compute client device location information based at least in part on a wave propagation parameter (WPP) extracted from the signal, if the transmitter ID is validated by the validator.

Example 12 includes the subject matter of Example 11, further comprising:

an application computer program including instructions to cause the processor to request the client device location information,

wherein the location calculator computer program instructions include further instructions to cause the processor to provide the computed client device location information to the application.

Example 13 includes the subject matter of Example 12, wherein the location calculator computer program instructions include further instructions to cause the processor to:

compute client device location information based on WPPs extracted from received signals from a pre-determined number of transmitters that is greater than one; and

deny the request if the pre-determined number of corresponding transmitter IDs are not validated by the validator.

Example 14 includes the subject matter of Example 11, wherein the validator computer program is implemented in the client device to which the client device location information relates.

Example 15 includes the subject matter of Example 11, wherein the location calculator computer program is implemented in the client device to which the client device location information relates.

Example 16 includes the subject matter of Example 11, wherein the validator and location calculator computer programs are each implemented in the client device to which the client device location information relates.

Example 17 includes the subject matter of Example 11, including:

a first non-transitory computer readable medium encoded with the application computer program instructions to cause a client device processor to request the client device location information; and

a second non-transitory computer readable medium encoded with the validator computer program instructions, including instructions to cause a management system processor to validate transmitter IDs for multiple client devices.

Example 18 includes the subject matter of Example 11, including;

a first non-transitory computer readable medium encoded with the application computer program instructions to cause a client device processor to request the client device location information; and

a second non-transitory computer readable medium encoded with the validator computer program instructions, including further instructions to cause a management system processor to selectively validate transmitter IDs extracted by multiple client devices.

Example 19 is a method to compute device location information, comprising:

receiving a signal at a client device from a transmitter and extracting a transmitter identifier (ID) and a wave propagation parameter (WPP) from the received signal;

validating the transmitter ID based on a list of pre-assigned transmitter IDs; and

computing client device location information based at least in part on the extracted WPP, if the transmitter ID is validated.

Example 20 includes the subject matter of Example 19, further comprising:

sending a request for the client device location information from an application program executing on the client device,

wherein the computing further includes providing the computed client device location information to the application.

Example 21 includes the subject matter of Example 20, wherein:

the receiving includes receiving signals from multiple transmitters and the extracting includes extracting a transmitter ID and a WPP from each of the signals;

the computing includes computing the client device location information based on the WPPs extracted from the received signals of a pre-determined number of the transmitters that is greater than one; and

the method further comprises denying the request if the pre-determined number of corresponding transmitter IDs are not validated.

Example 22 includes the subject matter of Example 19, wherein the validating is performed in the client device.

Example 23 includes the subject matter of Example 19, wherein the computing is performed in the client device.

Example 24 includes the subject matter of Example 19, wherein the validating and the computing are each performed in the client device.

Example 25 includes the subject matter of Example 19, wherein the validating is performed in a management system and includes validating transmitter IDs for multiple client devices.

Example 26 includes the subject matter of Example 19, wherein the computing is performed in a management system and includes computing location information for each of multiple client devices.

Example 27 includes at least one machine readable medium comprising a plurality of instructions that in response to being executed on a computing device, cause the computing device to carry out a method according to any one of Examples 19 to 26.

Example 28 includes a communications device arranged to perform the method of any one of Examples 19 to 26.

Example 29 is an apparatus to compute location information, configured to perform the method of any one of Examples 19 to 26.

Example 30 is a computer system to perform the method of any one of Examples 19 to 26.

Example 31 is a machine to perform the method of any one of Examples 19 through 26.

Example 32 is an apparatus comprising: means for performing the method of any one of Examples 19 to 26.

Example 33 is a computing device comprising a chipset according to any one of Examples 27-30 and memory to compute device location information.

Methods and systems disclosed herein may be implemented in circuitry and/or a machine, such as a computer system, and combinations thereof, including discrete and integrated circuitry, application specific integrated circuitry (ASIC), a processor and memory, and/or a computer-readable medium encoded with instructions executable by a processor, and may be implemented as part of a domain-specific integrated circuit package, a system-on-a-chip (SOC), and/or a combination of integrated circuit packages.

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

What is claimed is:

1. A system to compute device location information, comprising:
a client device including a receiver to receive a signal from a transmitter and to extract a transmitter identifier (ID) and a wave propagation parameter (WPP) from the signal;
a validator to validate the transmitter ID based on a list of pre-assigned transmitter IDs; and
a location calculator to compute client device location information based at least in part on the extracted WPP, if the transmitter ID is validated by the validator.

2. The system of claim 1, wherein:
the client device further includes an application to request the client device location information; and
the location calculator is further configured to provide the computed client device location information to the application.

3. The system of claim 2, wherein:
the receiver is configured to receive signals from multiple transmitters and to extract a transmitter ID and a WPP from each of the signals; and
the location calculator is configured to
compute client device location information based on the WPPs extracted from the received signals of a pre-determined number of the transmitters that is greater than one, and
deny the request if the pre-determined number of corresponding transmitter IDs are not validated by the validator.

4. The system of claim 1, wherein the client device includes the location calculator.

5. The system of claim 1, wherein the client device includes the validator.

6. The system of claim 1, wherein the client device includes the location calculator and the validator.

7. The system of claim 1, further including a management system, including the validator, wherein the validator is configured to validate transmitter IDs for multiple client devices.

8. The system of claim 1, further including a management system, including the location calculator, wherein the location calculator is configured to compute location information for each of multiple client devices.

9. The system of claim 1, wherein the client device further comprises:
a communication system that includes the receiver;
a user interface;
a processor and memory to communicate with the communication system and the user interface; and
a housing to house the communication system, the user interface, and the processor and memory.

10. The system of claim 9, wherein:
the communication system includes a wireless communication system; and
the housing includes a mobile hand-held housing to receive the communication system, the user interface, the processor and memory, and a battery.

11. A non-transitory computer readable medium encoded with:
a validator computer program including instructions to cause the processor to validate a transmitter ID extracted from a signal received at a client device from a transmitter based on a list of pre-assigned transmitter IDs; and
a location calculator computer program including instructions to cause the processor to compute client device location information based at least in part on a wave propagation parameter (WPP) extracted from the signal, if the transmitter ID is validated by the validator.

12. The non-transitory computer readable medium of claim 11, further comprising:
an application computer program including instructions to cause the processor to request the client device location information,
wherein the location calculator computer program instructions include further instructions to cause the processor to provide the computed client device location information to the application.

13. The non-transitory computer readable medium of claim 12, wherein the location calculator computer program instructions include further instructions to cause the processor to:
the compute client device location information based on WPPs extracted from received signals from a pre-determined number of transmitters that is greater than one; and
deny the request if the pre-determined number of corresponding transmitter IDs are not validated by the validator.

14. The non-transitory computer readable medium of claim 11, wherein the validator computer program is implemented in the client device to which the client device location information relates.

15. The non-transitory computer readable medium of claim 11, wherein the location calculator computer program is implemented in the client device to which the client device location information relates.

16. The non-transitory computer readable medium of claim 11, wherein the validator and location calculator computer programs are each implemented in the client device to which the client device location information relates.

17. The non-transitory computer readable medium of claim 11, including:
a first non-transitory computer readable medium encoded with the application computer program instructions to cause a client device processor to request the client device location information; and
a second non-transitory computer readable medium encoded with the validator computer program instructions, including instructions to cause a management system processor to validate transmitter IDs for multiple client devices.

18. The non-transitory computer readable medium of claim 11, including;
a first non-transitory computer readable medium encoded with the application computer program instructions to cause a client device processor to request the client device location information; and
a second non-transitory computer readable medium encoded with the validator computer program instructions, including further instructions to cause a management system processor to selectively validate transmitter IDs extracted by multiple client devices.

19. A method to compute device location information, comprising:
receiving a signal at a client device from a transmitter and extracting a transmitter identifier (ID) and a wave propagation parameter (WPP) from the received signal;
validating the transmitter ID based on a list of pre-assigned transmitter IDs; and
computing client device location information based at least in part on the extracted WPP, if the transmitter ID is validated.

20. The method of claim 19, further comprising:
sending a request for the client device location information from an application program executing on the client device,
wherein the computing further includes providing the computed client device location information to the application.

21. The method of claim 20, wherein:
the receiving includes receiving signals from multiple transmitters and the extracting includes extracting a transmitter ID and a WPP from each of the signals;
the computing includes computing the client device location information based on the WPPs extracted from the received signals of a pre-determined number of the transmitters that is greater than one; and
the method further comprises denying the request if the pre-determined number of corresponding transmitter IDs are not validated.

22. The method of claim 19, wherein the validating is performed in the client device.

23. The method of claim 19, wherein the computing is performed in the client device.

24. The method of claim 19, wherein the validating and the computing are each performed in the client device.

25. The method of claim 19, wherein the validating is performed in a management system and includes validating transmitter IDs for multiple client devices.

26. The method of claim 19, wherein the computing is performed in a management system and includes computing location information for each of multiple client devices.
